(19) United States
(12) Patent Application Publication
(10) Pub. No.: US 2007/0036949 A1
(43) Pub. Date: Feb. 15, 2007

(54) Fungi resistant sheet, facing and faced insulation assembly

(75) Inventors: Blake Boyd Bogrett, Littleton, CO (US); Ralph Michael Fay, Lakewood, CO (US)

Correspondence Address: Johns Manville;Intellectual Property (R21D), 10100 West Ute Avenue, Littleton, CO, 80127, US

(73) Assignee: Johns Manville International, Inc.

(21) Appl. No.: 11/584,709

(22) Filed: Oct. 20, 2006

Related U.S. Application Data
(63) Continuation of application No. 10/801,734, filed on Mar. 15, 2004, now abandoned.
Application No. 10/801,734 is a continuation-in-part of application No. 10/703,130, filed on Nov. 6, 2003, now abandoned.
Application No. 10/703,130 is a continuation-in-part of application No. 10/465,311, filed on Jun. 19, 2003, now abandoned.
Application No. 10/465,311 is a continuation of application No. 10/394,134, filed on Mar. 20, 2003, now abandoned.

(51) Int. Cl. B32B 11/06

(52) U.S. Cl. 428/192; 428/491

(57) ABSTRACT

A kraft paper sheet material includes a kraft paper sheet and an asphalt layer on one major surface of the kraft paper sheet that is partially absorbed into the kraft paper sheet. The asphalt layer has a fungi growth-inhibiting agent therein in amounts that result in the kraft paper sheet material having more fungi growth resistance than the kraft paper sheet without the asphalt coating layer. Water vapor transmission retarding facings for faced insulation assemblies and other water vapor transmission retarding coverings are made with kraft paper sheet material.

This patent application is a continuation-in-part of patent application Ser. No. 10/703130 filed Nov. 6, 2003, which is a continuation-in-part of patent application Ser. No. 10/465311 filed Jun. 19, 2003, which is a continuation of patent application Ser No. 10/394134 filed Mar. 20, 2003.

### BACKGROUND OF THE INVENTION

The subject invention relates to a fungi resistant kraft paper sheet material, facings made with the fungi resistant kraft paper sheet material for faced building insulation assemblies, such as but not limited to faced building insulation assemblies commonly used to insulate homes and other residential building structures; offices, stores and other commercial building structures; and industrial building structures, and to the faced building insulation assemblies faced with such facings. The kraft paper sheet material facings of the subject invention are designed to exhibit improved fungi growth-inhibiting characteristics and may also exhibit other improved performance characteristics such as but not limited to improved functionality to improve installer productivity.

Building insulation assemblies currently used to insulate buildings, especially fiberglass building insulations, are commonly faced with kraft paper facings, such as 30-40 lbs/3MSF (30 to 40 pounds/ 3000 square feet) natural kraft paper. In addition, U.S. Pat. Nos. 5,733,624; 5,746,854; 6,191,057; and 6,357,504 disclose examples of polymeric facings for use in faced building insulation assemblies and US patent application nos. US 2002/0179265 A1; US 2002/0182964 A1; and US 2002/0182965 A1 disclose examples of polymeric-kraft laminates for use in faced building insulation assemblies.

While building insulation assemblies faced with such kraft paper facings function quite well, have been used for decades, and the patents listed above disclose kraft paper facing materials as well as alternative facing materials, there has remained a need for facings with improved performance characteristics. The improved kraft paper sheet material of the subject invention, the improved kraft paper sheet material facings of the subject invention, and the building insulation assemblies faced with the improved kraft paper sheet material facings of the subject invention provide faced insulation assemblies designed to exhibit improved fungi growth-inhibiting characteristics over current kraft paper facings commonly used to face insulation assemblies.

### SUMMARY OF THE INVENTION

The fungi resistant kraft paper sheet material of the subject invention can be used for many applications where unwanted fungi growth is typically encountered. However, the fungi resistant kraft paper sheet material of the subject invention is particularly useful as a sheet material for the facings of the faced building insulation assemblies of the subject invention. The fungi resistant kraft paper sheet material of the subject invention and the facings of the subject invention, made with the fungi resistant kraft paper sheet material of the subject invention include a kraft paper sheet and an asphalt coating applied to one of the major surfaces of a kraft paper sheet that contains one or more fungi growth-inhibiting agents. The asphalt coating layer not only makes the kraft paper sheet more fungi resistant, but functions as vapor retarder to retard the transmission of water vapor through the fungi resistant kraft paper sheet material and as a bonding layer to bond the facings of the subject invention to insulation layers. The fungi resistant kraft paper sheet material of the subject invention; the facings of the subject invention made with the fungi resistant kraft paper sheet material of the subject invention; the facings of the subject invention as applied to the insulation layer to form faced building insulation assemblies of the subject invention; and the covering sheets of the subject invention applied over nonfaced insulation are preferably fungi growth resistant as defined herein and more preferably fungi growth resistant with no observable fungi growth as defined herein.

When a surface of a specimen of a kraft paper sheet material of the subject invention or a facing of the subject invention, as bonded to an insulation layer of a faced insulation assembly of the subject invention, and a surface of a comparative specimen of a white birch or southern yellow pine wood, which are each approximately 0.75 by 6 inches (20 by 150 mm), are tested as follows, the specimen of kraft paper sheet material or facing of the subject invention will have less spore growth than the comparative specimen of white birch or southern yellow pine. Spore suspensions of aspergillus niger, aspergillus versicolor, penicillium funiculosum, chaetomium globosum, and asperguillus flavus are prepared that each contain 1,000,000 ±200,000 spores per mL as determined with a counting chamber. Equal volumes of each of the spore suspensions are blended together to produce a mixed spore suspension. The 0.75 by 6 inch surface of the specimen of the kraft paper sheet material or facing of the subject invention and the 0.75 by 6 inch surface of the comparative specimen of white birch or southern yellow pine wood are each inoculated with approximately 0.50 mL of the mixed spore suspension by spaying the surfaces with a fine mist from a chromatography atomizer capable of providing 100,000 ±20,000 spores/ inch². The specimens are immediately placed in an environmental chamber and maintained at a temperature of 86 ±4° F. (30 ±2° C.) and 95 ±4% relative humidity for a minimum period of 28 days ±8 hours from the time incubation commenced (the incubation period). At the end of the incubation period, the specimens are examined at 40× magnification. The specimen of the kraft paper sheet material or facing of the subject invention made of the kraft paper sheet material passes the test provided the specimen of the kraft paper sheet material or facing has less spore growth than the comparative specimen of white birch or southern yellow pine wood. As used in this specification and claims the term “fungi growth resistant” means the observable spore growth at 40× magnification on the surface of a kraft paper sheet material or facing specimen being tested is less than the observable spore growth at 40× magnification on either a white birch or southern yellow pine comparative specimen when the specimens are tested as set forth herein in accordance with ASTM Standard Test Method for Determining Fungi Resistance of Insulation Materials and Facings C 1338- 00. As used in this specification and claims the term “fungi growth resistant with no observable fungi growth” means there is no observable spore growth at 40× magnification on the surface of a kraft paper sheet material or facing specimen being tested when the specimens are tested as set forth herein in accordance with ASTM Standard Test Method for Determining Fungi Resistance of Insulation Materials and Facings C 1338- 00.

As used in this specification and claims the term “kraft paper sheet” means a paper sheet derived from cellulose fibers and includes paper sheets such as but not limited to dyed kraft paper, bleached kraft paper, and natural kraft paper. As used herein the term “asphalt” includes both asphalt and modified asphalt, such as but not limited to one of the modified asphalts commonly used in the industry to bond facings to insulation layers. The asphalt coating layer may be applied to the major surface of the kraft paper sheet by various methods, such as but not limited to, applying the asphalt to one major surface of the kraft paper sheet with a slot die extrusion coater; applying the asphalt to one major surface of the kraft paper sheet with a transfer roll; and applying the asphalt to one major surface of the kraft paper sheet by conventional spray on techniques. The asphalt coating layer may be pre-applied to the facing or applied to the facing and/or a major surface of the insulation layer at the point where the facing and the insulation layer are being combined. For example, the asphalt coating layer may be applied to the kraft paper sheet immediately prior to applying the kraft paper sheet material thus formed to a major surface of an insulation layer while the asphalt is still hot or the asphalt coating layer may be preapplied to the kraft paper sheet and the kraft paper sheet material thus formed reheated for application to a major surface of an insulation layer. The asphalt layer of the kraft paper sheet material of the subject invention has a softening point temperature sufficiently low to enable the asphalt layer to be heated to a temperature to effect a bond between the facing and a major surface of the insulation layer without degrading the facing. The asphalt layer of the facing of the subject invention will typically increase the water repellency of the kraft paper sheet and thereby make the facing less susceptible to fungi growth by reducing the presence of moisture in the insulation assembly. In addition, the kraft paper sheet, with the asphalt layer, exhibits a reduced water vapor permeance rating and functions as a water vapor and/or air transmission retarder to reduce the passage of water vapor and/or air through kraft paper sheet material of the subject invention and facings of the subject invention.

The facing of the subject invention may have lateral tabs, may be tabless, or may have lateral tabs made from a sheet material that differs from the sheet material of the field portion of the facing and that are sufficiently transparent to enable framing members to be seen through the tabs, sufficiently open to enable wallboard to be directly bonded to framing members overlaid by the tabs, and/or sufficiently greater in integrity than the field portion of the facing to permit a less expensive material to be used for the field portion of the facing. The field portion of the facing of the subject invention may include a mineral coating (e.g. clay coating) layer with or without modifiers or a polymeric coating or film layer with or without modifiers that is applied to the kraft paper sheet material.

The facing of the subject invention may be formed from a gusseted tubular sheet material. The facing of the subject invention may be separable longitudinally at spaced apart locations in the central field portion of the facing so that the facing can be applied to a pre-cut longitudinally separable insulation layer and separated where the pre-cut longitudinally separable insulation layer is separable. The building insulation assembly of the subject invention may have a laterally compressible resilient insulation layer faced with a tabless facing having portions, e.g. lateral edge portions, which may be separated from the insulation layer when the insulation layer is laterally compressed to form lateral tabs in place that extend laterally beyond the compressed insulation layer. The fungi growth resistant kraft paper sheet material of the subject invention, typically in widths of about four feet or more, may be applied as a vapor passage retarding covering directly to the framing members of a wall where unfaced insulation is used to insulate the wall cavities.

### BRIEF DESCRIPTION OF THE DRAWINGS

FIG. 1 is a schematic perspective view of a first embodiment of the faced insulation assembly of the subject invention.

FIG. 2 is a schematic end view of the faced insulation assembly of FIG. 1.

FIG. 3 is a schematic view of the circled portion of FIG. 2 on a larger scale than FIG. 2.

FIGS. 4 and 5 are schematic views of faced insulation assemblies of FIGS. 1 to 3 installed in a wall cavity.

FIG. 6 is partial schematic view of another embodiment of the faced insulation assembly of the subject invention showing a tab strip bonded to one of the tabs of the facing of FIGS. 1 to 3.

FIG. 7 is a schematic transverse cross section though a tubular sheet material with lateral gussets that can be made into a facing of the subject invention.

FIG. 8 is a schematic transverse cross section through the tubular sheet material of FIG. 7 after the tubular sheet material has been collapsed and bonded together.

FIGS. 9 to 12 are partial schematic views of embodiments of the faced insulation assembly of the subject invention showing other tabs that may be substituted for the tabs shown on the facing of FIGS. 1 to 3. The partial schematic views of FIGS. 9 to 12 correspond to the view of FIG. 3 for the embodiment of FIGS. 1 to 3.

FIG. 13 is a schematic end view of a faced pre-cut insulation assembly with a facing of the subject invention that is longitudinally separable at each location where the insulation layer is longitudinally separable.

FIG. 14 is a schematic end view of a faced pre-cut insulation assembly with a facing of the subject invention that is longitudinally separable at each location where the insulation layer is longitudinally separable and provided with tabs at each location where the insulation layer is separable.

FIG. 15 is schematic view of the circled portion of FIG. 14 on a larger scale than FIG. 14.

FIG. 16 is a schematic end view of a faced insulation assembly of the subject invention where the facing is without preformed tabs.

FIG. 17 is a schematic end view of a faced pre-cut insulation assembly with a facing of the subject invention that has no preformed tabs and is longitudinally separable at each location where the insulation layer is longitudinally separable.

FIG. 18 is a schematic view of the circled portion of FIG. 17 on a larger scale than FIG. 17.

FIGS. 19 and 20 are partial elevations of walls insulated with unfaced insulation batts that are overlaid by coverings formed by any of the kraft paper sheet materials of the subject invention.

FIG. 21 is a partial schematic cross section through a kraft paper sheet material of the subject invention.

### DESCRIPTION OF THE PREFERRED EMBODIMENTS

The kraft paper sheet material 10 of the subject invention shown in FIG. 24 is a paper sheet derived from cellulose fibers such as but not limited to dyed, bleached, or natural kraft paper sheet 12 (such as but not limited to a 35-38 lbs/3MSF natural kraft paper, a 30-40 lbs/3MSF lightweight kraft paper, or a 35-38 lbs/3MSF extensible natural kraft paper) with an asphalt coating layer 14 on a first major surface of the kraft paper sheet that is partially absorbed into the kraft paper sheet. Preferably, the asphalt coating layer 14 is coextensive with or substantially coextensive with the first major surface of the kraft paper sheet 12. The kraft paper sheet 12 forms a first major surface of the kraft paper sheet material 10 and the asphalt coating layer 14 forms a second major surface of the kraft paper sheet material 12. The asphalt coating layer is preferably applied to the kraft paper sheet in amounts ranging from about 0.03 to about 0.05 kilograms per square meter (about 6 to about 10 pounds per 1000 square feet) and contains one or more fungi growth inhibiting agents that make the kraft paper sheet material, including both major surfaces of the first sheet material, fungi resistant. While the asphalt coating layer 14 is absorbed into the kraft paper sheet 12 of the kraft paper sheet material 10, preferably, there is little or no asphalt bleed through to the kraft paper sheet and the second major surface of the kraft paper sheet is essentially free of asphalt. By keeping the second major surface of the kraft paper sheet 12 essentially free of asphalt, the asphalt does not adversely discolor or otherwise adversely affect the appearance or handling of a facing made of the kraft paper sheet material.

The kraft paper sheet material 10: has more fungi growth resistance than the kraft paper sheet 12 has by itself; preferably, is fungi growth resistant (as defined herein); and more preferably, is fungi growth resistant with no observable fungi growth (as defined herein). Typically, the kraft paper sheet 12 by itself is not fungi growth resistant (as defined herein).

The kraft paper sheet 12 has a preferred Gurley Hill porosity of at least 20. The preferred porosity of the a kraft paper sheet 12 facilitates the partial absorption by the kraft paper sheet 12 of the asphalt coating layer 14 applied to the first major surface of the sheet the kraft paper sheet with little or no bleed through of the asphalt to the second major surface of the kraft paper sheet so that the kraft paper sheet material 10 is fungi resistant with an essentially asphalt free second major surface. By itself, the kraft paper sheet 12 is too permeable to function as a vapor retarder for many facing applications. However, by combining the kraft paper sheet 12 with the asphalt coating layer 14, the permeance of the kraft paper sheet material 10 may be set so that kraft paper sheet material 10 functions as a vapor retarder to retard the transmission of water vapor through the kraft paper sheet material to a desired degree. For example, the kraft paper sheet material 10 may be coated with the asphalt coating layer so that the kraft paper sheet material (as measured in accordance with ASTM Test Designation: E 96-00 entitled “Standard Test Methods for Water Vapor Transmission of Materials”) exhibits a water vapor permeance rating no greater than 1 and, more preferably, approximately 1 grain/ft²/hour/inch Hg (no greater than 1 perm and more preferably, approximately 1 perm); a water vapor permeance rating between 1 and 10 grain/ft²/hour/inch Hg (between 1 perm and 10 perms); or a water vapor permeance rating greater than 10 grain/ft2/hour/inch Hg (greater than 10 perms) to provide a vapor retarder or barrier for a faced fibrous insulation blanket, e.g. a faced resilient fiberglass insulation blanket, and other insulation assemblies or systems.

It should be noted that the fungi growth-inhibiting agent used in asphalt coating layer 14 may comprise one fungi growth-inhibiting agent or a combination or blend of two or more fungi growth-inhibiting agents to provide a broader or more efficacious fungi growth resistance for the kraft paper sheet material 10 and that the fungi growth-inhibiting agent should be able to withstand temperatures in excess of 150° C. (300°F.) for long periods of time, e.g. periods of up to about 12 hours, and, preferably, temperatures in excess of 175° C. (350° F.) for periods up to 60 minutes without significant degradation. The following are examples of fungi growth inhibiting agents that withstand the above temperatures for the specified times without significant degradation: 2-(4-Thiazolyl) Benzimidazole (a chemical also known as “TBZ”) sold by Ciba Specialty Chemicals under the trade designation Iraguard F 3000; silver zeolyte sold by Rohm & Haas Company under the trade designation KATHON; and Zinc Pyrithione sold by Arch Chemicals Inc. under the trade designation Zinc Omadine.

In a preferred kraft paper sheet material 10 of the subject invention, the kraft paper sheet material 10 contains between 200 and 2000 ppm (parts per million), more preferably between 300 and 700 ppm, and most preferably between 400 and 600 ppm of the fungi growth-inhibiting agent 2-(4-Thiazolyl) Benzimidazole (a chemical also known as “TBZ”). In another preferred kraft paper sheet material 10 of the subject invention, the asphalt coating layer 14 contains at least 1.5 grams of 2-(4-Thiazolyl) Benzimidazole (“TBZ”) per each 100 square meters of coating. As mentioned above, the asphalt coating layer 14 is preferably applied to the kraft paper sheet in amounts ranging from about 0.03 to about 0.05 kilograms per square meter (about 6 to about 10 pounds per 1000 square feet). The inclusion of 2-(4-Thiazolyl) Benzimidazole (“TBZ”) in the asphalt coating layer 14 rather than incorporating the 2-(4-Thiazolyl) Benzimidazole (“TBZ”) in the kraft paper sheet during the manufacture of the kraft paper sheet has proved to be very beneficial. When tested in accordance with ASTM Standard Test Method for Determining Fungi Resistance of Insulation Materials and Facings Designation: C 1338-00, a kraft paper sheet material 10 using a particular kraft paper sheet with an asphalt coating layer containing about 2 grams of 2-(4-Thiazolyl) Benzimidazole (“TBZ”) per 1000 square feet of coating (about 2 grams of 2-(4-Thiazolyl) Benzimidazole (“TBZ”) per each 92.9 square meters of coating) had a fungi growth resistance substantially equal to the fungi growth resistance of an otherwise identical kraft paper sheet containing about 5 grams of 2-(4-Thiazolyl) Benzimidazole (“TBZ”) per each 1000 square feet of kraft paper sheet (about 5 grams of 2-(4-Thiazolyl) Benzimidazole (“TBZ”) per each 92.9 square meters of the kraft paper sheet). Thus, for similar efficacy against fungi growth, the inclusion of the 2-(4-Thiazolyl) Benzimidazole (“TBZ”) in the asphalt of the asphalt coating layer 14 resulted in about a 60% reduction in the usage of 2(4-Thiazoly) Benzimidazole (“TBZ”).

Samples of the standard asphalt used by Johns Manville International to form the asphalt coating layers on facings of kraft faced building insulation were modified by adding quantities of TBZ and/or Zinc Pyrithione to the asphalt-in parts per million (ppm). Five specimens of the asphalt with and without the TBZ and/or Zinc Pyrithione additives were then one-side coated on glass fiber filter paper (this type of filter paper does not support mold growth and is used as a noncontributing carrier for the asphalt). A sample of the number four specimen of asphalt was also one-side coated on regular 35 pound per 3000 square feet natural kraft paper to form specimen number 6. The variations shown in the table below were tested in triplicate for mold growth resistance in accordance with ASTM Test Designation G 21-96 (Reapproved 2002) entitled “Standard Practice for Determining Resistance of Synthetic Polymeric Materials to Fungi”.

| | | TBZ | Zinc | | | | |
|---|---|---|---|---|---|---|---|
| Specimen | Specimen ID | ppm | ppm | Week 1 | Week 2 | Week 3 | Week 4 |
| 1 | Asphalt Coated Filter Paper | 0 | 0 | 0, 0, 1 | 2, 1, 3 | 3, 3, 4 | 4, 4, 4 |
| 2 | Asphalt Coated Filter Paper | 500 | 0 | 0, 0, 0 | 0, 0, 0 | 0, 0, 1 | 0, 0, 1 |
| 3 | Asphalt Coated Filter Paper | 0 | 600 | 2, 2, 2 | 2, 3, 3 | 3, 3, 4 | 3, 4, 4 |
| 4 | Asphalt Coated Filter Paper | 500 | 600 | 0, 0, 0 | 0, 0, 0 | 0, 0, 0 | 0, 0, 0 |
| 5 | Asphalt Coated Filter Paper | 250 | 300 | 0, 0, 0 | 0, 0, 0 | 0, 0, 0 | 0, 0, 0 |
| 6 | Asphalt Coated Kraft Paper | 500 | 600 | 1, 1, 1 | 2, 2, 2 | 3, 3, 3 | 3, 3, 4 |

ASTM Test Designation G-21 has the following ratings for observed fungi growth on specimens (Sporulating or Non-Sporulating, or Both):

| | Rating |
|---|---|
| None | 0 |
| Traces of Growth (less than 10% coverage) | 1 |
| Light Growth (10% to 30% coverage) | 2 |
| Medium Growth (30% to 60% coverage) | 3 |
| Heavy Growth (60% to complete coverage) | 4 |

The results indicate the following:

1. The asphalt with no fungi growth-inhibiting additives supports fungi growth and is not very fungi resistant.

2. TBZ added to the asphalt makes the asphalt dramatically more fungi resistant.

3. Zinc Pyrithione added to the asphalt at the 600 ppm level does not provide a measurable fungi resistance benefit.

4. TBZ used in combination with Zinc Pyrithione makes the asphalt dramatically more fungi resistant even at relatively low addition levels. The results suggest a synergistic benefit from the blend of these two fungi growth inhibiting agents.

5. Theory suggests that a secondary heating of specimen 6, by passing the specimen over a hot roll as when a facing is reheated prior to its application to an insulation layer, would enhance the fungi resistance of the uncoated side of specimen and provide better results than those recorded above for specimen 6.

The asphalt of the asphalt coating layer may contain an odor-reducing additive in an amount sufficient to significantly reduce and substantially neutralize the asphalt odor that would otherwise be emitted by the asphalt coating layer without adversely affecting the adherent qualities of the asphalt coating layer. For example the asphalt of the asphalt coating layer may include an odor-reducing additive of essential plant oil in an amount approximating 1 part by weight odor-reducing additive to 10,000 parts by weight asphalt.

Where the kraft paper sheet of the kraft paper sheet material includes a mineral coating (e.g. a clay coated 30-40 lbs/3MSF kraft paper laminate or a clay coated 20-30 lbs/3MSF kraft paper laminate), polymeric coating (e.g. a 20-30 lb/3MSF natural kraft that is coated with an outer white-pigmented HDPE film layer such as an HDPE film layer applied at a weight of about 7-15 lbs/3MSF), or ink coating layer, a fungi growth-inhibiting agent or fungi growth-inhibiting agent and pesticide also may be included in any one or more of the coating layers. At a relatively low cost, the mineral coating layer increases the stiffness and body of the kraft paper sheet material, the integrity of the kraft paper sheet material, the “cuttability” of the kraft paper sheet material, the “cuffability” (ability of the kraft paper sheet material to hold a fold when forming tabs), and the fire resistance of the kraft paper sheet material.

Preferably, each kraft paper sheet material and facing of the subject invention, as bonded to the insulation layer, passes the ASTM Test Designation C 1338-00, entitled “Standard Test Method for Determining Fungi Resistance of Insulation Materials and Facings”, published August 2000, by ASTM International of West Conshohocken, Pa. (referred to in this specification and claims as “ASTM Test Designation C 1338-00”). More preferably, each kraft paper sheet material and facing of the subject invention is fungus resistant (as defined in section 11.2 of the test) as tested by ASTM Test Designation D 2020 - 92 (Reapproved 1999), entitled “Standard Test Methods for Mildew (Fungus) Resistance of Paper and Paperboard”, published August 1992 (referred to in this specification and claims as “ASTM Test Designation D 2020-92”). Most preferably, each kraft paper sheet material and facing of the subject invention has a rating of 0 (as defined in section 9.3 of the test) as tested by ASTM Test Designation G 21-96 (Reapproved 2002), entitled “Standard Practice for Determining Resistance of Synthetic Polymeric Materials to Fungi”, published September 1996 (referred to in this specification and claims as “ASTM Test Designation G 21-96”). The text of ASTM Test Designations C 1338-00, D 2020-92, and G 21-96 referred to in this paragraph are hereby incorporated into this specification in their entirety by reference.

As discussed above, asphalt coating layer 14 may be applied to the kraft paper sheet 12 to form the kraft paper sheet material 10 by different methods. For example, the asphalt coating layer 14 may be applied to the first major surface of the kraft paper sheet 12 with a slot die extrusion coater; with a transfer roll; or with the use of conventional spray on techniques. The asphalt coating layer 14 is applied to the kraft paper sheet 10 with the asphalt heated to temperatures in excess of 120° C. (250° F.) and typically, with the asphalt heated to temperatures. in excess of 150° C. (300° F.). At these temperatures, the asphalt of the asphalt coating layer 14 is absorbed into the kraft paper sheet 12 by a wicking or capillary action without degrading the kraft paper sheet and the fungi growth-inhibiting agent in the asphalt increases the fungi growth resistance of the kraft paper sheet throughout the kraft paper sheet including the uncoated second major surface of the kraft paper sheet. Preferably, the asphalt coated kraft paper sheet forms a kraft paper sheet material 10 that is fungi growth resistant (as defined herein) and more preferably fungi growth resistant with no observable fungi (as defined herein).

When the kraft paper sheet material 10 is used as a facing, the asphalt coating layer 14 may be pre-applied to the kraft paper sheet 12 to form a facing for later application to an insulation layer or the asphalt coating layer 14 may be applied to the kraft paper sheet 12 in an on line process where the facing and the insulation layer are being combined. When the asphalt coating layer 14 is preapplied to the kraft paper sheet 10 to form a facing for later application to an insulation layer, the asphalt layer of the facing is reheated immediately prior to the application of the facing to a major surface of an insulation layer; the facing is applied to the insulation layer while the asphalt is still hot and tacky; and the asphalt is allowed to cool to bond the facing to the insulation layer. The secondary heating of the preapplied asphalt in this process may cause the asphalt to further penetrate the kraft paper sheet to make the kraft paper sheet material 10 more fungi resistant. When the asphalt coating layer 14 is applied to the kraft paper sheet 12 to form the facing immediately prior to applying the facing thus formed to an insulation layer, the facing is applied to a major surface of the insulation layer while the asphalt is still hot and tacky and the asphalt is allowed to cool to bond the facing to the major surface of an insulation layer.

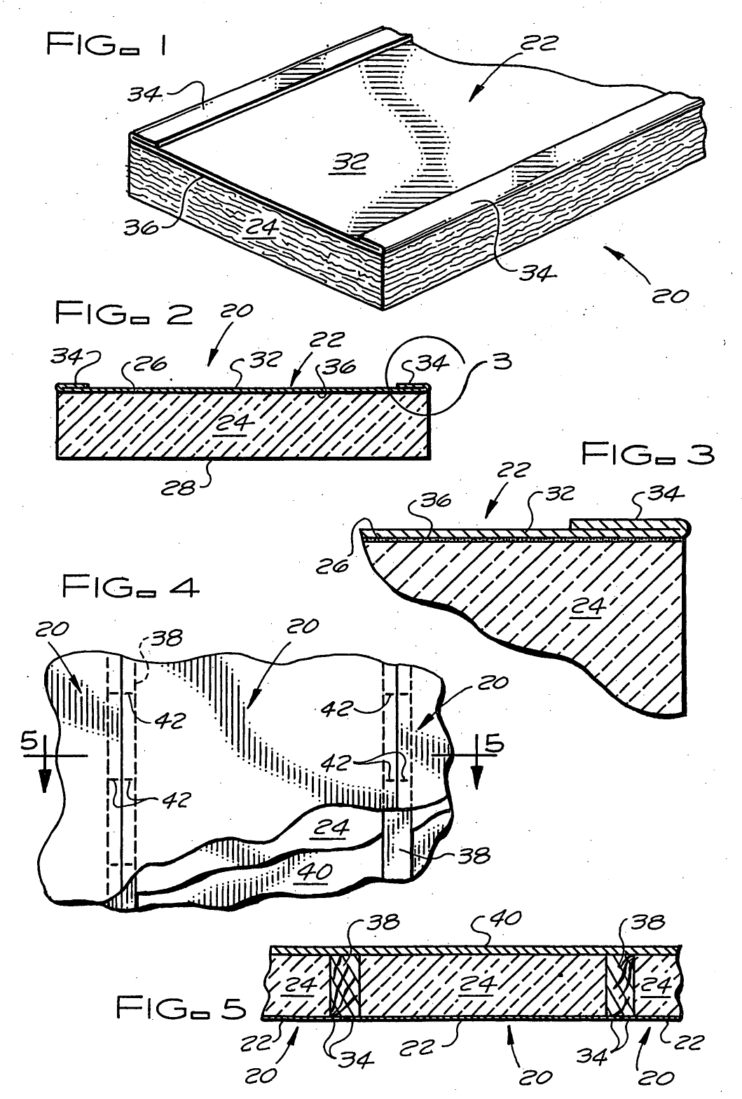

FIGS. 1 and 2 show a typical faced insulation assembly 20 of the subject invention. The faced insulation assembly 20 includes a facing 22 of the subject invention made from the kraft paper sheet material of the subject invention and an insulation layer 24. The insulation layer 24 has first and second major surfaces 26 and 28, which are defined by the length and width of the insulation layer, and a thickness. The facing 22 of the faced insulation assembly 20 is formed of a kraft paper sheet material of the subject invention and has a central field portion 32 and a pair of lateral tabs 34 that are typically between 0.25 and 1.5 inches in width. The lateral tabs 34 can be unfolded and extended beyond the lateral surfaces of the insulation layer 24 of the faced insulation assembly 20 (typically extended between 0.25 and 1.5 inches beyond the lateral surfaces of the insulation layer) for attachment to framing members forming a cavity being insulated by the faced insulation assembly and/or unfolded and extended beyond the lateral surfaces of the insulation layer 24 of the faced insulation assembly 20, e.g. to overlap the framing members forming a cavity being insulated by the faced insulation assembly. The central field portion 32 of the sheet has a first outer major surface and a second inner major surface. The central field portion 32 of the sheet overlays and is bonded by an asphalt bonding layer 36 on the inner major surface of central field portion 32 of the sheet to the major surface 26 of the insulation layer 24.

FIGS. 4 and 5 show faced insulation assemblies 20 installed in a wall cavity defined on three sides by two spaced apart framing members 38 (e.g. wooden 2×4 or 2×6studs) and a sheet of sheathing 40. As shown in FIG. 4, the tabs 34 of the faced insulation assemblies 20 are secured to the end surfaces of the framing members 38 by staples 42. While the insulation assemblies 20 are shown installed in wall cavities, the insulation assemblies 20 may also be installed between framing members in other building cavities such as but not limited to ceiling, floor, and roof cavities. While, as shown, the tabs 34 are stapled to the end surfaces of the faming members 38, the tabs may be stapled to the side surfaces of the framing members 38, may be bonded to the end surfaces of the framing members 38 or the side surfaces of the framing members 38, may overlap end surfaces of the framing members 38 without being secured to the framing members, or, if desired, may be left in their initial folded configuration.

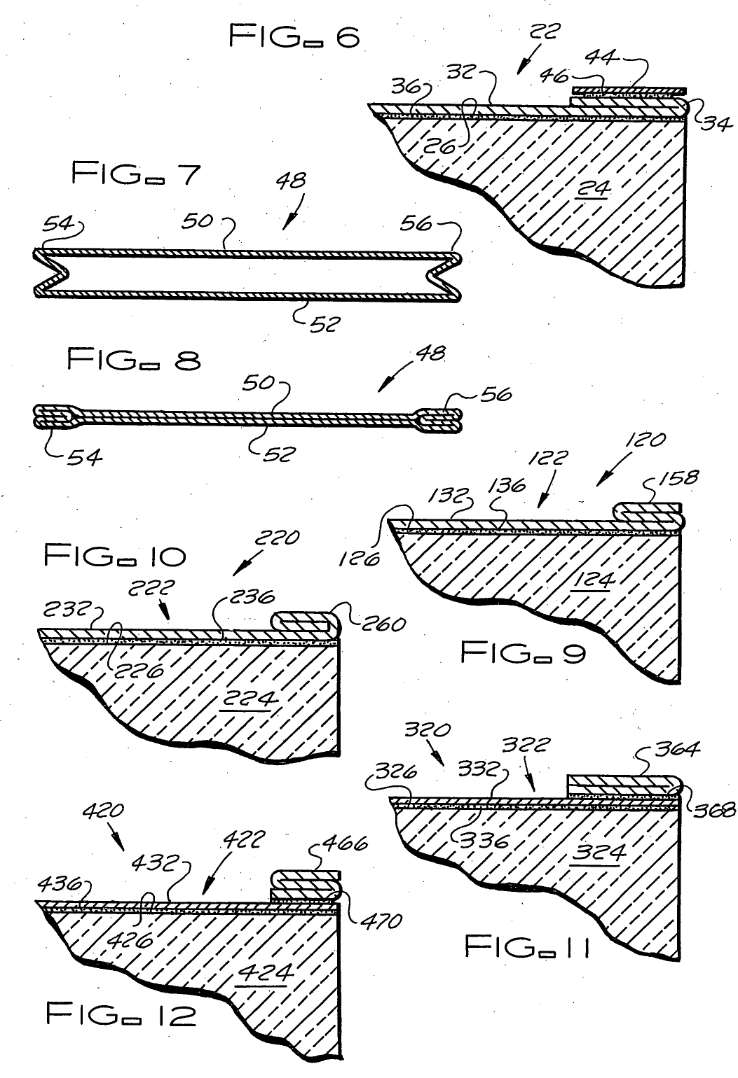

FIG. 6 shows a partial cross section of the facing 22 of FIGS. 1 to 3 that corresponds to FIG. 3 wherein the lateral tabs 34 include tab strips 44. The lateral tabs 34 each have a tab strip 44 that overlays, is coextensive or essentially coextensive with, and is bonded to one surface of the lateral tab 34. The tab strips 44 provide the lateral tabs 34 with increased integrity relative to central field portion 32 of the facing sheet 22 for handling and stapling and may be selected to have sufficient integrity to enable the use of thinner and/or less expensive sheet materials for the facing sheet 22. In addition, the tab strips 44 may also function as release liners overlaying layers or coatings 46 of pressure-sensitive adhesives on the lateral tabs 34 that may be used to secure the lateral tabs 34 to framing members 38.

While the insulation layers faced with the facings of the subject invention may be made of other materials, such as but not limited to foam insulation materials, preferably, the insulation layers of the insulation assemblies of the subject invention are resilient fibrous insulation blankets and, preferably, the faced conventional uncut resilient fibrous insulation blankets and the faced pre-cut resilient fibrous insulation blankets of the subject invention are made of randomly oriented, entangled, glass fibers and typically have a density between about 0.3 pounds/ft 3 and about 1.6 pounds/ft³. Examples of fibers that may be used other than or in addition to glass fibers to form the faced resilient insulation blankets of the subject invention are mineral fibers, such as but not limited to, rock wool fibers, slag fibers, and basalt fibers; organic fibers such as but not limited to polypropylene, polyester and other polymeric fibers; natural fibers such as but not limited to cellulose, wood, flax and cotton fibers; and combinations of such fibers. The fibers in the faced resilient insulation blankets of the subject invention may be bonded together at their points of intersection for increased integrity, e.g. by a binder such as but not limited to a polycarboxy polymers, polyacrylic acid polymers, a urea phenol formaldehyde or other suitable bonding material, or the faced resilient fibrous insulation blankets of the subject invention may be binder-less provided the blankets possess the required integrity and resilience.

While the faced resilient fibrous insulation blankets of the subject invention may be in roll form (typically in excess of 117 inches in length), for most applications, such as the insulation of walls in homes and other residential structures, the faced resilient fibrous insulation blankets of the subject invention are in the form of batts about 46 to about 59 inches in length (typically about 48 inches in length) or 88 to about 117 inches in length (typically about 93 inches in length). Typically, the widths of the faced resilient fibrous insulation blankets are substantially equal to or somewhat greater than standard cavity width of the cavities to be insulated, for example: about 15 to about 15½ inches in width (a nominal width of 15 inches) for a cavity where the center to center spacing of the wall, floor, ceiling or roof framing members is about 16 inches (the cavity having a width of about 14 ½ inches); and about 23 to about 23½ inches in width (a nominal width of 23 inches) for a cavity where the center to center spacing of the wall, floor, ceiling or roof framing members is about 24 inches (the cavity having a width of about 22½ inches). However, for other applications, the faced resilient fibrous insulation blankets may have different initial widths determined by the standard widths of the cavities to be insulated by the insulation blankets.

The amount of thermal resistance or sound control desired and the depth of the cavities being insulated by the faced insulation assemblies determine the thicknesses of the faced insulation assemblies of the subject invention, e.g. faced resilient fibrous insulation blankets. Typically, the faced insulation assemblies are about three to about ten or more inches in thickness and approximate the depth of the cavities being insulated. For example, in a wall cavity defined in part by nominally 2×4 or 2×6 inch studs or framing members, a faced pre-cut resilient fibrous insulation blanket will have a thickness of about 3½ inches or about 5 ½ inches, respectively.

The facing 22 of the faced insulation assembly 20 and the other facings and water vapor transmission retarding coverings of the other insulation assemblies and systems of the subject invention may be formed from a collapsed tubular kraft paper sheet material of the subject invention that includes first and second lateral gusset portions. FIGS. 7 and 8, show the tubular sheet material 48 prior to and after the sheet has been collapsed and prior to the application of the asphalt coating layer to form the facing. The tubular sheet material has first and second central portions 50 and 52 extending between and joining the two lateral gusset portions 54 and 56. The central portions 50 and 52 of the collapsed tubular sheet material are bonded together to form the central field portion of the facing sheet. As shown the lateral gusset portions 54 and 56 each include four layers while the central portion of the collapsed tubular sheet material includes two layers. By including an additional lateral gusset or gussets, the lateral gusset portions could each include six or more layers. The inclusion of additional layers in each of the lateral gusset portions 54 and 56 of the collapsed tubular sheet material relative to the central portion of the collapsed tubular sheet material enables the formation of lateral tabs on the facing of increased integrity and tear through resistance while using a thinner or less expensive sheet material to form collapsed tubular sheet material.

FIGS. 9 to 20 show additional embodiments of the faced insulation assembly of the subject invention. The faced insulation assemblies of FIGS. 9 to 20 include facings of the subject invention made from the kraft paper sheet material of the subject invention and an insulation layer. The elements of the faced insulation assemblies of FIGS. 9 to 20 that correspond to those of FIGS. 1 to 3 will have corresponding reference numerals in the hundreds with the same last two digits as the reference numerals-used for those elements in FIGS. 1 to 3. Unless otherwise stated, the elements of FIGS. 9 to 20 identified with reference numerals having the same last two digits as the reference numerals referring to those elements in FIGS. 1 to 3 are and function the same as those of FIGS. 1-3.

FIG. 9 shows a partial cross section of a faced insulation assembly 120 of the subject invention with a facing sheet 122 that has Z-folded tabs 158 (only one of which is shown) and FIG. 10 shows a partial cross section of a faced insulation assembly 220 with of the subject invention that has C-folded tabs 260 (only one of which is shown) that can be unfolded and extended beyond the lateral surface of the insulation layer 124 or 224 for attachment to and/or to overlay framing members. The Z-folded tabs 158 and C-folded tabs 260 are substituted for the tabs 34, are typically between about 0.25 and about 1.5 inches in width, and typically can be extended beyond the lateral surfaces of the insulation layers 124 and 224 between about 0.25 and about 1.5 inches. Like the central field portion 32 and lateral tabs 34 of facing 22, the central field portion 132 and lateral tabs 158 of facing 122 and the central field portion 232 the lateral tabs 260 of the facing 222 are made from the same. piece of sheet material.

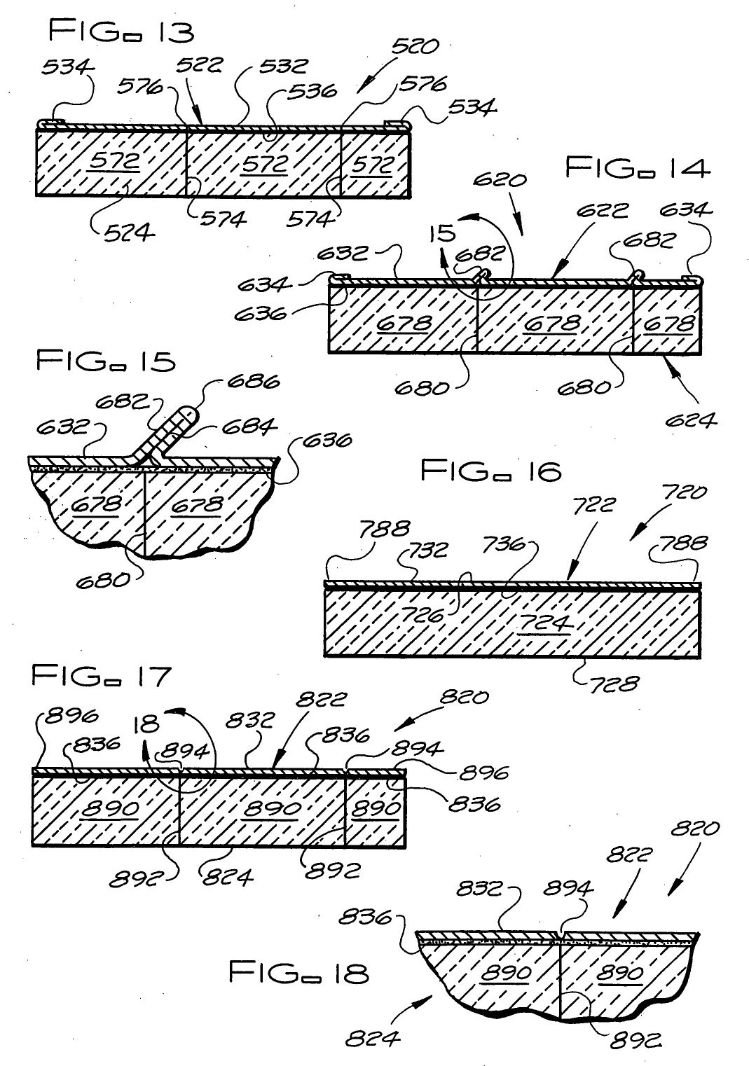

FIGS. 11 and 12 show partial cross sections of additional embodiments 320 and 420 of the faced insulation assembly of the subject invention. In the facings 322 and 422 of the embodiments 320 and 420, lateral tabs 364 and 466 are substituted for the lateral tabs 34 of facing 22. The tabs 364 and 466 are made of materials that differ from the material used to form the central field portions 332 and 432 of the facings 322 and 422; are bonded by adhesive layers 368 and 470, by ultra sonic welding or by other bonding means to the upper surface of lateral edge portions of the central field portion 332 and 432 of the facings 322 and 422; and are typically between about 0.25 and about 1.5 inches in width. The tab 364 of the faced insulation assembly 320 is like the tab 34 of the faced insulation assembly 20. The tab 466 of the faced insulation assembly 420 of FIG. 12 is a Z-folded tab. The tabs 364 and 466 can be unfolded and extended beyond the lateral surfaces of the insulation layers 324 and 424 (typically extended between 0.25 and 1.5 inches beyond the lateral surfaces of the insulation layers) for attachment to or to overlay framing members.

FIG. 13 shows an embodiment 520 of the faced insulation assembly of the subject invention wherein both the facing 522 and the insulation layer 524 are longitudinally separable to form faced insulation sections 572 having lesser widths than the faced insulation assembly 520. The insulation layer 524 has one or more longitudinally extending series of cuts and separable connectors, schematically represented by lines 574, which enable the insulation layer 524 to be pulled apart or separated by hand into the insulation sections 572 of lesser widths than the insulation layer 524. For each such series of cuts and separable connectors 574 in the insulation layer 524, the field portion 532 of the sheet 530 forming the facing 522 has a line of weakness 576 therein that is longitudinally aligned with the series of cuts and separable connectors so that the facing can also be separated or pulled apart by hand at each series of cuts and separable connectors. The line of weakness 576 may be formed as a perforated line, as an etched score line that reduces the thickness of the sheet material along the line, or the line may be otherwise weakened to facilitate the separation of the facing sheet by hand along the line 576. Other than the one or more series of cuts and separable connectors 574. in the insulation layer 524 and the one or more lines of weakness 576 in the facing 522, the faced insulation assembly 520 of FIG. 13 is the same as the faced insulation assembly 20.

FIGS. 14 and 15 show an embodiment 620 of the faced insulation assembly of the subject invention wherein both the facing 622 and the insulation layer 624 are longitudinally separable to form faced insulation sections 678 having lesser widths than the faced insulation assembly 624. The insulation layer 624 has one or more longitudinally extending series of cuts and separable connectors, schematically represented by lines 680, which enable the insulation layer 624 to be pulled apart or separated by hand into the insulation sections 678 of lesser widths than the insulation layer 624. For each such series of cuts and separable connectors 678 in the insulation layer 624, the field portion 632 of the sheet 630 forming the facing 622 has a fold 682 therein that is longitudinally aligned with the series of cuts and separable connectors. The two segments of each fold 682 are separably bonded to each other and, typically, the fold line 686 joining the segments of each fold 682 will be perforated, scored, or otherwise weakened to permit the fold to be pulled apart or separated by hand at the fold line 686 to form tab segments. Preferably, each segment of each fold 682 is between about 0.25 and about 1.5 inches in width. Other than the one or more series of cuts and separable connectors 680 in the insulation layer 624 and the one or more folds 682 in the facing 622 with weakened fold lines 686, the faced insulation assembly 620 of FIGS. 14 and 15 is the same as the faced insulation assembly 20.

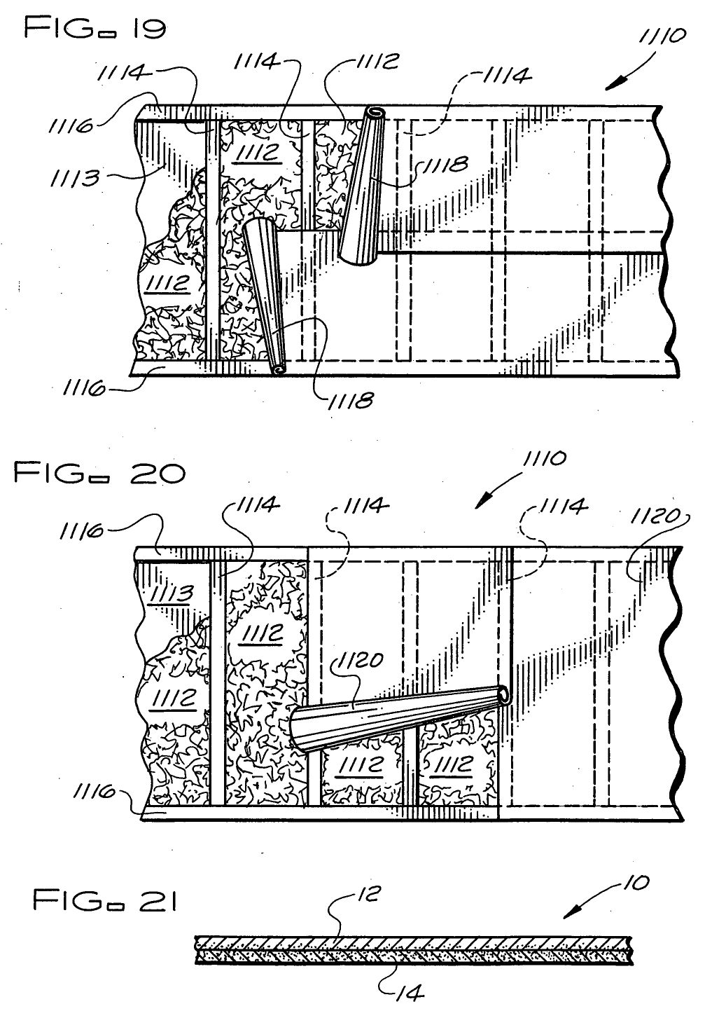

FIG. 16 shows a faced insulation assembly 720 of the subject invention that is faced with a facing 722 of the subject invention without preformed tabs. The faced insulation assembly 720 of FIG. 16 includes the facing 722 and an insulation layer 724. Preferably, the insulation layer 724 is made of a resilient insulation material, such as but not limited to a fiberglass insulation, that can be compressed in the direction of its width, e.g. laterally compressed an inch or more, and, after the compressive forces are released, will recover or substantially recover to its initial width. The insulation layer 724 has first and second major surfaces 726 and 728, which are defined by the length and width of the insulation layer, and a thickness. The facing 722 of the faced insulation assembly 720 is formed by a sheet material that has a central field portion 732, that is substantially coextensive with the first major surface of the insulation layer 724, but has no preformed tabs. The central field portion 732 of the facing 722 has a first outer major surface and a second inner major surface. The central field portion 732 of the facing 722 overlays and is bonded, by an asphalt bonding layer 736 on and coextensive with the inner major surface of central field portion 732 of the facing, to the major surface 726 of the insulation layer 724. The asphalt bonding layer 736 bonding the central field portion 732 of the facing 722 to the first major surface 726 of the insulation layer 724 extends to the lateral edges of the insulation layer 724 and the facing 722. When the insulation layer 724 is compressed laterally to fit between a pair of framing members that are spaced apart a distance less than the width of the faced insulation assembly 720, the lateral edge portions 788 of the facing 722 can be separated from the insulation layer to extend beyond the lateral surfaces of the laterally compressed insulation layer 724 (e.g. between 0.25 and 1.5 inches) to form lateral tabs. However, if the installer does not desire to form lateral tabs on the facing 722 that extend laterally beyond the insulation layer when the insulation layer is compressed laterally, the installer can leave the lateral edge portions 788 of the facing 722 bonded to the lateral edge portions of the major surface 726 of the insulation layer.

FIGS. 17 and 18 show an embodiment 820 of the faced insulation assembly of the subject invention wherein both the facing 822 and the insulation layer 824 are longitudinally separable to form faced insulation sections 890 having lesser widths than the faced insulation assembly 820 Like the faced insulation assembly 720 of FIG. 16, the facing of faced insulation assembly 820 does not have preformed tabs and the insulation layer 824 is preferably made of a resilient insulation material, such as but not limited to a fiberglass insulation, that can be compressed in the direction of its width, e.g. laterally compressed an inch or more, and, after the compressive forces are released, will recover or substantially recover to its initial width. The insulation layer 824 has one or more longitudinally extending series of cuts and separable connectors, schematically represented by lines 892, which enable the insulation layer 824 to be pulled apart or separated by hand into the insulation sections 890 of lesser widths than the insulation layer 824. For each such series of cuts and separable connectors 892 in the insulation layer 824, the field portion 832 of the sheet 830 forming the facing 822 has a line of weakness 894 therein that is longitudinally aligned with the series of cuts and separable connectors and can be pulled apart or separated by hand. The line of weakness 894 may be formed as a perforated line, as an etched score line that reduces the thickness of the sheet material along the line, or the line may be otherwise weakened to facilitate the separation of the facing sheet along the line 894. The bonding layer 836 bonding the central field portion 832 of the facing to the first major surface 826 of the insulation layer 824 is coextensive with the central field portion of the facing.

When the insulation layer 824 of faced insulation assembly 820 is compressed in the direction of its width to fit between a pair of framing members that are spaced a distance less than the width of insulation layer 824, the lateral edge portions 896 of the facing sheet can be separated from the major surface 826 of the insulation layer and extended as tabs beyond the lateral surfaces of the laterally compressed insulation layer 824 to provide a water vapor transmission retarding barrier between the facing and the framing members and/or for attachment to the framing members. When an insulation section 890 of faced insulation assembly 820 is compressed in the direction of its width to fit between a pair of framing members that are spaced a distance less than the width of insulation section 890, the portions of the facing sheet adjacent the lateral surfaces of the compressed insulation section 890 (portions 896 and/or 898) can be separated from the major surface 826 of the insulation layer and extended as tabs beyond the lateral surfaces of the laterally compressed insulation section 890 to provide a water vapor transmission retarding barrier between the facing and the framing members and/or for attachment to the framing members. However, the installer may choose to leave the facing 822 bonded to the major surface of the insulation layer so that no lateral tabs are formed on the insulation layer or sections of the insulation layer when they are compressed laterally.

FIGS. 19 and 20 show hollow building walls 1110 with cavities that are insulated with unfaced insulation balts 1112, e.g. unfaced fiberglass insulation batts. The wall cavities are each defined by: a wall covering 1113 (such as but not limited to sheathing or gypsum board that is shown where the insulation batts 1112 are broken away); spaced-apart vertically extending framing members 1114 (e.g. studs); and horizontally extending framing members 1116 (e.g. wall plates).

In FIG. 19, upper and lower sheets 1118, which are partially peeled back to show the insulation bafts and framing structure of the wall 1110, overlay the unfaced insulation balts 1112. The sheets 1118 may be made of any of the kraft paper sheet materials of the subject invention. As applied to the framing members 1114 and 1116, the asphalt free major surface of the kraft paper sheet material is exposed and the asphalt coated major surface of the kraft paper sheet material overlies the framing members. The longitudinal centerlines of the sheets 1118 extend horizontally with the lower lateral edge portion of the upper sheet and upper lateral edge portion of the lower sheet overlapping each other so that the sheets 1118 form a water vapor transmission retarding layer of the wall. The sheets 1118 may be unrolled from rolls of the sheet material, cut to desired lengths, and secured to the framing members 1114 and 1116 by staples, beads of adhesive preapplied to the framing members, or by other securing means. Preferably, the sheets 1118 have thicknesses between 2 and 6 mils and have widths that enable the sheets to be overlapped by several inches and, together, extend for the entire height of the wall, e.g. for a eight foot high wall the sheets 1118 may each be about fifty inches in width and about twenty to about three hundred feet in length. It is also contemplated that one sheet could be used rather than the two sheets 1118 and that such a sheet would be about eight feet in width for an eight-foot high wall.

In FIG. 20, side-by-side sheets 1120, which are partially peeled back to show the insulation batts and framing structure of the wall 1110, overlay the unfaced insulation batts 1112. The sheets 1120 may be made of any of the kraft paper sheet materials of the subject invention. As applied to the framing members 1114 and 1116, the asphalt free major surface of the kraft paper sheet material is exposed and the asphalt coated major surface of the kraft paper sheet material overlies the framing members. The longitudinal centerlines of the sheets 1120 extend vertically with the lateral edge portions of adjacent sheets 1120 being secured to the same vertical frame member 1114 or overlapping each other so that the sheets 1120 form a water vapor transmission retarding layer of the wall. The sheets 1120 may be unrolled from rolls of the sheet material (e.g. rolls from about twenty to about three hundred feet in length), cut to desired lengths, and secured to the framing members 1114 and 1116 by staples, beads of adhesive preapplied to the framing members, or by other securing means. The sheets 1120 may have widths equal to the standard center to center spacing of the vertical frame members 1114 in a wall, e.g. 16 or 24 inch widths, so that the sheets each can overlie a single wall cavity and be secured to the vertical frame members defining the cavity. However, preferably, the sheets 11204 have thicknesses between 2 and 6 mils and have widths that are multiples of the standard cavity widths for a wall e.g. 32, 48, 64, 72, 84, or 96 inch widths that enable the sheets to overlie a plurality of wall cavities and be secured to vertical frame members 1114 of the wall.

In describing the invention, certain embodiments have been used to illustrate the invention and the practices thereof. However, the invention is not limited to these specific embodiments as other embodiments and modifications within the spirit of the invention will readily occur to those skilled in the art on reading this specification. Thus, the invention is not intended to be limited to the specific embodiments disclosed, but is to be limited only by the claims appended hereto.

1-72. (canceled)

73. A faced building insulation assembly, comprising:
an insulation layer; the insulation layer having a length, a width and a thickness; the insulation layer having first and second major surfaces defined by the length and width of the layer;
a facing comprising a kraft paper sheet material that overlays the first major surface of the insulation layer; the kraft paper sheet material comprising a kraft paper sheet having a first inner major surface and a second outer major surface and an asphalt coating layer on the first inner major surface of the kraft paper sheet; the asphalt coating layer being partially absorbed into the kraft paper sheet and bonding the kraft paper sheet material to the first major surface of the insulation layer; and the asphalt coating layer being an asphaltic material consisting essentially of asphalt, a blend of two or more fungi growth-inhibiting agents, which can withstand temperatures of about 150° C. or more for periods of up to about 12 hours without significant degradation whereby the asphaltic material can be applied to the kraft paper sheet material at temperatures to facilitate absorption of the asphaltic material into the kraft paper sheet material in amounts that result in the kraft paper sheet material having more fungi growth resistance than the kraft paper sheet without the asphalt layer; and
the second major surface of the kraft paper sheet being essentially free of the asphaltic material whereby the asphaltic material of the asphalt coating layer does not discolor or otherwise adversely affect the facing in appearance.

74. The faced building insulation assembly according to claim 73, including:
an essential plant oil odor-reducing additive in an amount sufficient to substantially eliminate odor that would otherwise be emitted by the asphalt coating layer.

75. The faced building insulation assembly according to claim 73, wherein:
the kraft paper sheet material consists essentially of the kraft paper sheet and the asphalt coating layer on the second major surface of the kraft paper sheet.

76. The faced building insulation assembly according to claim 73, wherein:
the kraft paper sheet material consists essentially of the kraft paper sheet, the asphalt coating layer on the second major surface of the kraft paper sheet, and a mineral coating layer on the first major surface of the kraft paper sheet for increasing stiffness, cuttability, cuffability, and fire resistance of the kraft paper sheet material.

77. The faced building insulation assembly according to claim 73, wherein:
the kraft paper sheet material consists essentially of the kraft paper sheet, the asphalt coating layer on the second major surface of the kraft paper sheet, and a white-pigmented HDPE coating layer on the first major surface of the kraft paper sheet.

78. The faced building insulation assembly according to claim 73, wherein:
the insulation layer is laterally compressible; and
the facing is substantially coextensive with the first major surface of the insulation layer and the facing has no preformed lateral tabs.

79. The faced building insulation assembly according to claim 73, wherein:
the insulation layer is laterally compressible; the insulation layer is separable longitudinally by hand at a location spaced inwardly from lateral edge surfaces of the insulation layer; and
the kraft paper sheet material has a longitudinally extending line of weakness that extends for the length of the kraft paper sheet material, is spaced inwardly from lateral edges of the kraft paper sheet material, and is aligned with the separable location in the insulation layer to facilitate separation by hand of kraft paper sheet material along the separable location in the insulation layer.

80. The faced building insulation assembly according to claim 73, wherein:
the fungi growth-inhibiting agents of the asphaltic material of the asphalt coating layer comprise 2-(4-Thiazolyl) Benzimidazole and Zinc Pyrithione.

81. The faced building insulation assembly according to claim 73, wherein:
the kraft paper sheet material has a water vapor permeance no greater than 1.

82. The faced building insulation assembly according to claim 73, wherein:
the kraft paper sheet has a Gurley Hill porosity of at least 20 to facilitate the partial absorption of by the kraft paper sheet of the asphalt coating layer.

83. An insulation system for a building wall, floor or ceiling; the wall, floor or ceiling comprising a series of cavities that are each defined in part by spaced apart parallel extending framing members; the insulation system comprising:
unfaced fibrous insulation batts contained within each of the series of cavities; and
a water vapor transmission retarding covering overlying the series of cavities and secured to the faming members defining the cavities; the water vapor transmission retarding covering comprising a kraft paper sheet material roll good having a length and a width and a thickness between 2 and 6 mils; the kraft paper sheet material comprising a kraft paper sheet with a first major surface and a second major surface and an asphalt coating layer on the first major surface of the kraft paper sheet; the asphalt coating layer being partially absorbed into the kraft paper sheet; and the asphalt coating layer being an asphaltic material consisting essentially of a blend of two or more fungi growth-inhibiting agents, which can withstand temperatures in excess of 150° C. for periods of up to about 12 hours without significant degradation whereby the asphaltic material can be applied to the kraft paper sheet material at temperatures in excess of 150° C. to facilitate absorption of the asphaltic material into the kraft paper sheet material in amounts that result in the kraft paper sheet material having more fungi growth resistance than the kraft paper sheet without the asphalt layer, and an essential plant oil odor-reducing additive in an amount sufficient to substantially eliminate odor that would otherwise be emitted by the asphalt coating layer; and the second major surface of the kraft paper sheet being essentially free of the asphaltic material whereby the asphaltic material of the asphalt coating layer does not discolor or otherwise adversely affect the facing in appearance.

84. The insulation system according to claim 83, wherein:
the kraft paper sheet material consists essentially of the kraft paper sheet and the asphalt coating layer on the second major surface of the kraft paper sheet.

85. The insulation system according to claim 83, wherein:
the kraft paper sheet material consists essentially of the kraft paper sheet, the asphalt coating layer on the second major surface of the kraft paper sheet, and a mineral coating layer on the first major surface of the kraft paper sheet for increasing stiffness, cuttability, cuffability, and fire resistance of the kraft paper sheet material.

86. The insulation system according to claim 83, wherein:
the kraft paper sheet material consists essentially of the kraft paper sheet, the asphalt coating layer on the second major surface of the kraft paper sheet, and a HDPE coating layer on the first major surface of the kraft paper sheet.

87. The insulation system according to claim 83, wherein:
the fungi growth-inhibiting agents of the asphaltic material of the asphalt coating layer comprise 2-(4-Thiazolyl) Benzimidazole and Zinc Pyrithione.
